(19) United States
(12) Patent Application Publication
(10) Pub. No.: US 2025/0370175 A1
(43) Pub. Date: Dec. 4, 2025

(54) OPTICAL STRUCTURE

(71) Applicant: VisEra Technologies Company Limited, Hsin-Chu City (TW)

(72) Inventors: Cheng-Ta MU, Hsin-Chu City (TW); Chung-Lun KUO, Hsin-Chu City (TW)

(21) Appl. No.: 18/676,875

(22) Filed: May 29, 2024

(51) Int. Cl. G02B 5/20

(52) U.S. Cl. CPC G02B 5/208

(57) ABSTRACT

An optical structure is provided. The optical structure includes a substrate and a first stack disposed on the substrate. The first stack includes alternately stacked first low-refractive-index films and semiconductor films. The optical structure further includes a second stack disposed on the first stack. The second stack includes alternately stacked second low-refractive-index films and high-refractive-index films. The refractive index of each first low-refractive-index film and each second low-refractive-index film is less than the refractive index of each high-refractive-index film.

### BACKGROUND OF THE INVENTION

### Field of the Invention

The present disclosure relates to an optical structure, and, in particular, to an optical structure that may be used as a near infrared (NIR) filter.

### Description of the Related Art

Optical sensing devices often include integrated circuits (ICs), which may use a package having a detector (e.g., photodetector) to detect light. More specifically, in some cases, light may be reflected from an object back to the detector. The detector produces a representation (e.g., an electrical signal) of the detected light. The representation may be processed and used as desired to obtain information about the object, such as the color of the object, relative motion of the object, or the approximate distance of the object to the sensing apparatus.

Reflected light, which carries information about an object, is susceptible to interference from undesired light waves. Optical filters may utilize filter transmission technology to attenuate or prevent unwanted light waves from reaching the detector, while allowing reflected light to be detected by the detector.

Near infrared (NIR) filters have received considerable interest due to their applications in various fields, which may include, but are not limited to NIR spectroscopy, security imaging, optical detections, and so on. However, there are still significant challenges in in how to effectively filter visible light and achieve high transmittance into infrared light.

### BRIEF SUMMARY OF THE INVENTION

According to the embodiment of the present disclosure, the optical structure includes a first stack and a second stack disposed on the first stack. The first stack and the second stack each includes specific stacked films, which may effectively filter visible light and achieve high transmittance into infrared light.

An embodiment of the present disclosure provides an optical structure. The optical structure includes a substrate and a first stack disposed on the substrate. The first stack includes alternately stacked first low-refractive-index films and semiconductor films. The optical structure further includes a second stack disposed on the first stack. The second stack includes alternately stacked second low-refractive-index films and high-refractive-index films. The refractive index of each first low-refractive-index film and each second low-refractive-index film is less than the refractive index of each high-refractive-index film.

In some embodiment, the semiconductor films include amorphous silicon.

In some embodiment, the first low-refractive-index films and the second low-refractive-index films include silicon dioxide, aluminum oxide, silicon nitride, or a combination thereof.

In some embodiment, the high-refractive-index films include titanium dioxide, niobium(V) oxide, tantalum(V) oxide, silane, or a combination thereof.

In some embodiment, the substrate includes glass.

In some embodiment, the thickness of the i-th first low-refractive-index film among the first low-refractive-index films in the first stack is Aᵢ×cᵢ×L, the thickness of the i-th semiconductor films among the semiconductor films in the first stack is Aᵢ×dᵢ×M, where L, M are λ/4 optical thickness, λ is a design wavelength or a wavelength being optimized for peak performance, Aᵢ×cᵢ×L and Aᵢ×dᵢ×M are set to cut off light with a wavelength of 300 nm to 600 nm, Aᵢ means a bracket coefficient and stands for a scale factor of a design wavelength, and cᵢ, dᵢ mean the times of λ/4 optical thickness.

In some embodiment, Aᵢ is adjustable to make different cut-on wavelengths of the optical structure.

In some embodiment, Aᵢ, is greater than or equal to 0.1 and less than or equal to 1.5, cᵢ, is greater than or equal to 0 and less than or equal to 2.5, and dᵢ, is substantially equal to 1.

In some embodiment, the thickness of the j-th second low-refractive-index film among the second low-refractive-index films in the second stack is Aⱼ×cⱼ×L, the thickness of the j-th high-refractive-index film among the high-refractive-index films in the second stack is Aⱼ×dⱼ×H, the thickness of a second low-refractive-index film among the second low-refractive-index films closest to the substrate is cₖ×L, where L, H are λ/4 optical thickness, λ is a design wavelength or a wavelength being optimized for peak performance, Aⱼ×cⱼ×L, Aⱼ×dⱼ×H, and cₖ×L are set to cut off light with a wavelength of about 600 nm to about 800 nm, Aⱼ means the bracket coefficient and stands for the scale factor of the design wavelength, and cⱼ, dⱼ, cₖ mean the times of λ/4 optical thickness.

In some embodiment, Aⱼ is adjustable to make different cut-on wavelengths of the optical structure.

In some embodiment, Aⱼ is greater than or equal to 0.1 and less than or equal to 1.5, cⱼ, cₖ are greater than or equal to 0 and less than or equal to 2.5, and dⱼ is substantially equal to 1.

In some embodiment, the cut-on wavelength of the optical structure is from 850 nm to 1550 nm.

In some embodiment, the average transmittance of the optical structure is less than or equal to 10⁻⁵ in the range of visible light wavelengths.

In some embodiment, the total number of the first low-refractive-index films, the semiconductor films, the second low-refractive-index films, and the high-refractive-index films is thirty to seventy-five.

In some embodiment, the total thickness of the first stack and the second stack is from 5 μm to 6 μm.

In some embodiment, the refractive index of the first low-refractive-index films and the second low-refractive-index films is less than or equal to 1.5.

In some embodiment, the refractive index of the high-refractive-index films is greater than 1.5.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a partial cross-sectional view illustrating the optical structure according to some embodiments of the present disclosure.

FIG. 2 is an example of the optical structure.

FIG. 3 illustrates different cut-on wavelengths according to some embodiments of the present disclosure.

FIG. 4 illustrates different transmissions of incident lights that have different wavelengths into the optical structure according to some embodiments of the present disclosure.

FIG. 5 illustrates different transmissions of incident lights that have different wavelengths into the optical structure in a logarithmic scale (or log scale) according to some embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

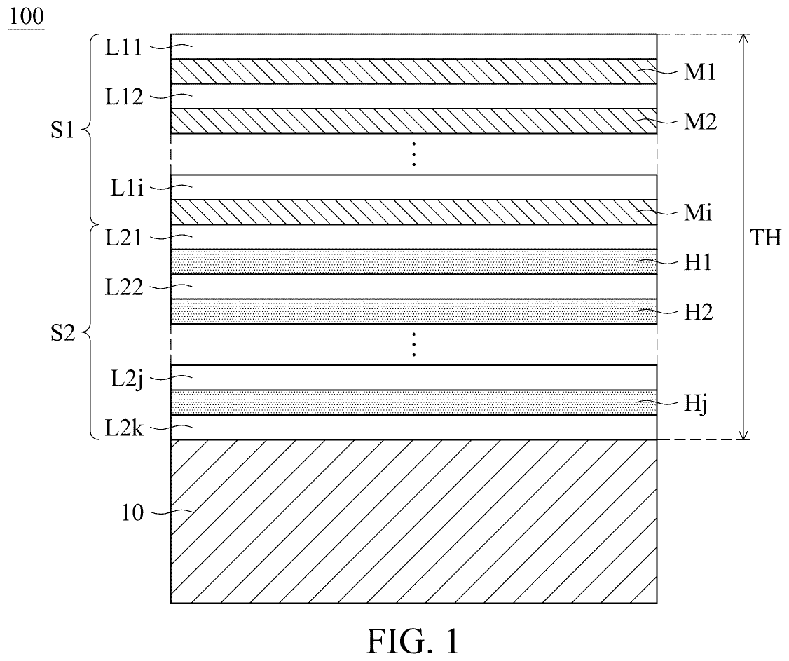

FIG. 1 is a partial cross-sectional view illustrating the optical structure 100 according to some embodiments of the present disclosure. It should be noted that some components of the optical structure 100 have been omitted in FIG. 1 for the sake of brevity.

The optical structure 100 may be used as a near infrared (NIR) filter. Referring to FIG. 1, in some embodiment, the optical structure 100 includes a substrate 10. In this embodiments, the substrate 10 includes glass, but the present disclosure is not limited thereto.

Referring to FIG. 1, in some embodiment, the optical structure 100 includes a first stack S1 disposed on the substrate 10. The first stack S1 includes alternately stacked first low-refractive-index films L11, L12, to L1i and semiconductor films M1, M2, to Mi, where i is a positive integer greater than 2. Here, i stands for i-th first low-refractive-index film or i-th semiconductor film from top to bottom in the first stack S1.

For example, the first low-refractive-index film L11 is the 1st first low-refractive-index film, the first low-refractive-index film L12 is the 2nd first low-refractive-index film, and the first low-refractive-index film L1i is the i-th first low-refractive-index film. Similarly, the semiconductor films M1 is the 1st semiconductor film, the semiconductor film M2 is the 2nd semiconductor film, and the semiconductor film Mi is the i-th semiconductor film.

In this embodiment, the first low-refractive-index films L11, L12, to L1i include silicon dioxide (SiO₂), aluminum oxide (Al₂O₃), silicon nitride (SiN), any other low-refractive-index material, or a combination thereof. Moreover, in this embodiment, the semiconductor films M1, M2, to Mi include amorphous silicon (a-Si).

Referring to FIG. 1, in some embodiment, the optical structure 100 includes a second stack S2 disposed on the first stack S1. The second stack S2 includes alternately stacked second low-refractive-index films L21, L22, to L2j, L2k and high-refractive-index films H1, H2, to Hj, where j, k is a positive integer greater than 2 and k is greater than j. Here, j stands for j-th second low-refractive-index film or j-th high-refractive-index film from top to bottom in the second stack S2, and k stands for k-th second low-refractive-index film which is the bottommost film in the second stack S2 and closest to the substrate 10.

For example, the second low-refractive-index film L21 is the 1st second low-refractive-index film, the second low-refractive-index film L22 is the 2nd second low-refractive-index film, and the second low-refractive-index film L2j is the j-th second low-refractive-index film. Similarly, the high-refractive-index films H1 is the 1st high-refractive-index film, the high-refractive-index film H2 is the 2nd high-refractive-index film, and the high-refractive-index film Hj is the j-th high-refractive-index film.

In this embodiment, the second low-refractive-index films L21, L22, to L2j also include silicon dioxide (SiO₂), aluminum oxide (Al₂O₃), silicon nitride (SiN), any other low-refractive-index material, or a combination thereof. That is, the second low-refractive-index films L21, L22, to L2j may be the same as or similar to the first low-refractive-index films L11, L12, to L1i, but the present disclosure is not limited thereto. Moreover, in this embodiment, the high-refractive-index film H1, H2, to Hj include titanium dioxide (TiO₂), niobium (V) oxide (Nb₂O₅), tantalum (V) oxide (Ta₂O₅), silane (SiH₄), any other high-refractive-index material, or a combination thereof.

In some embodiments, the refractive index of each first low-refractive-index film (e.g., first low-refractive-index film L11, L12, to L1i) and each second low-refractive-index film (e.g., second low-refractive-index film L21, L22, to L2j, or L2k) is less than the refractive index of each high-refractive-index film (e.g., high-refractive-index film H1, H2, to Hj). In this embodiment, the refractive index of each first low-refractive-index film (e.g., first low-refractive-index film L11, L12, to L1i) and each second low-refractive-index film (e.g., second low-refractive-index film L21, L22, to L2j, or L2k) is less than or equal to about 1.5, while the refractive index of each high-refractive-index film (e.g., high-refractive-index film H1, H2, to Hj) is greater than about 1.5.

In some embodiments, the thickness of the i-th first low-refractive-index film among the first low-refractive-index films (e.g., first low-refractive-index films L11, L12, to L1i) in the first stack S1 is Aᵢ×cᵢ×L, the thickness of the i-th semiconductor films among the semiconductor films (e.g., semiconductor films M1, M2, to Mi) in the first stack S1 is Aᵢ×dᵢ×M, where L, M are λ/4 optical thickness, and λ is the design wavelength or wavelength being optimized for peak performance. Aᵢ×cᵢ×L and Aᵢ×dᵢ×M are set to cut off light with a wavelength of about 300 nm to about 600 nm. Here, Aᵢ means the bracket coefficient and stands for the scale factor of the design wavelength, and cᵢ, dᵢ mean the times of λ/4 optical thickness.

Aᵢ is adjustable to make different cut-on wavelengths of the optical structure 100. In this embodiment, Aⱼ is greater than or equal to about 0.1 and less than or equal to about 1.5, cᵢ is greater than or equal to 0 and less than or equal to about 2.5, and dᵢ is substantially equal to 1.

In some embodiments, the thickness of the j-th second low-refractive-index film among the second low-refractive-index films (e.g., second low-refractive-index films L21, L22, to L2j) in the second stack S2 is Aⱼ×cⱼ×L, the thickness of the j-th high-refractive-index film among the high-refractive-index films (e.g., high-refractive-index films H1, H2, to Hj) in the second stack is Aⱼ×dⱼ×H, the thickness of the second low-refractive-index film L2k among the second low-refractive-index films closest to the substrate is cₖ×L, where L, H are λ/4 optical thickness, and λ is the design wavelength or wavelength being optimized for peak performance. Aⱼ×cⱼ×L, Aⱼ×dⱼ×H, and cₖ×L are set to cut off light with a wavelength of about 600 nm to about 800 nm. Here, Aⱼ means the bracket coefficient and stands for the scale factor of the design wavelength, and cⱼ, dⱼ, cₖ mean the times of λ/4 optical thickness.

Aⱼ is adjustable to make different cut-on wavelengths of the optical structure 100. In this embodiment, Aⱼ is greater than or equal to about 0.1 and less than or equal to about 1.5, cⱼ, cₖ are greater than or equal to 0 and less than or equal to about 2.5, and dⱼ is substantially equal to 1.

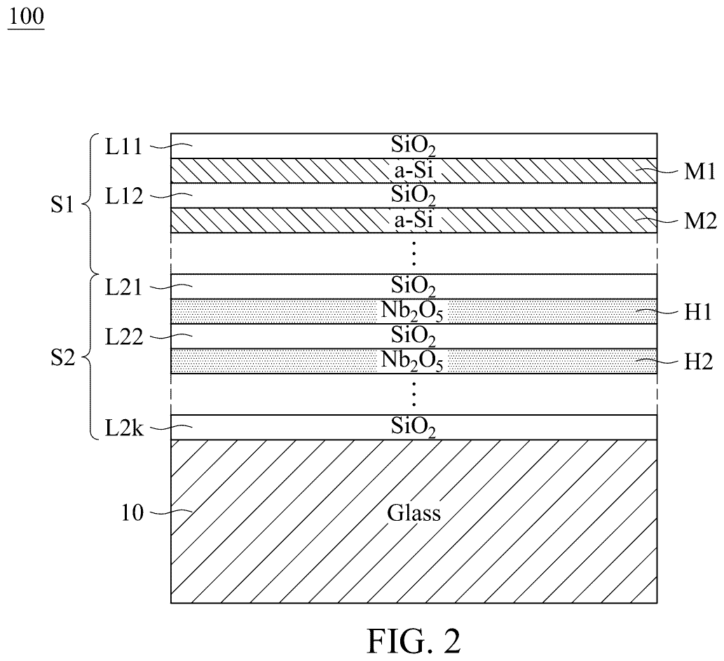

FIG. 2 is an example of the optical structure 100. As shown in FIG. 2, the substrate 10 is a glass substrate, the first stack S1 is disposed on the substrate 10 and includes alternately stacked silicon dioxide (SiO₂) and amorphous silicon (a-Si) (i.e., the first low-refractive-index films (L11, L12) may be silicon dioxide (SiO₂) and the semiconductor films (M1, M2) may be amorphous silicon (a-Si)), and the second stack S2 is disposed on the first stack S1 and includes alternately stacked silicon dioxide (SiO₂) and niobium (V) oxide (Nb₂O₅) (i.e., the second low-refractive-index films (L21, L22, L2k) may be silicon dioxide (SiO₂) and the high-refractive-index films (H1, H2) may be niobium (V) oxide (Nb₂O₅).

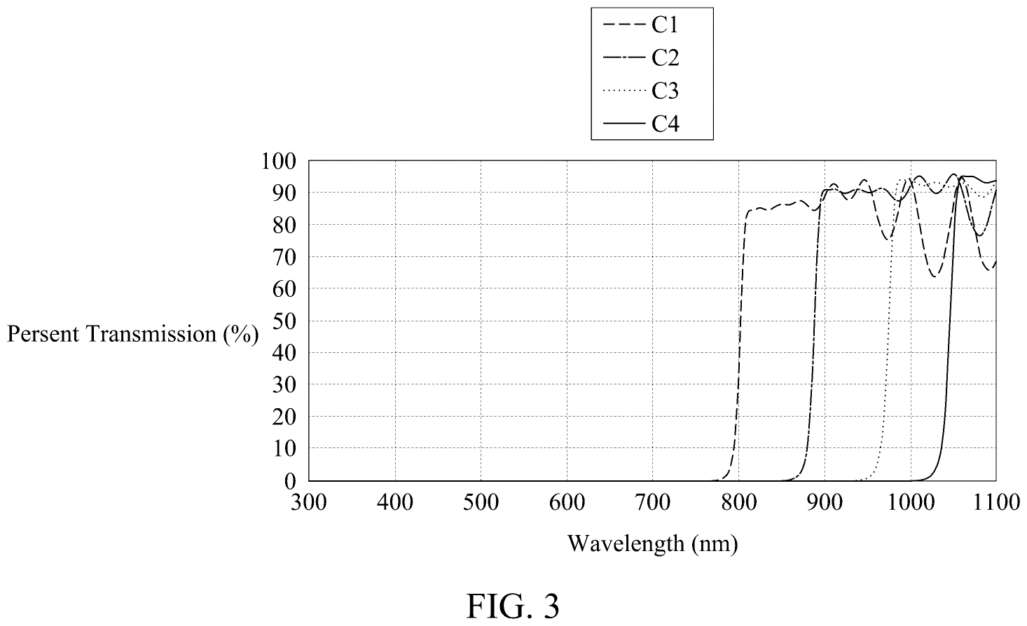

FIG. 3 illustrates different cut-on wavelengths according to some embodiments of the present disclosure, where X-axis represents wavelength (unit: nm) and Y-axis represents percent transmission (%). Here, cut-on wavelength is a term used to denote the wavelength at which the transmission increases to 50% (T50) throughput in a long-pass filter.

In these embodiments, the first low-refractive-index films L11, L12, to L1i are silicon dioxide (SiO₂), the semiconductor films semiconductor films M1, M2, to Mi are amorphous silicon (a-Si), the second low-refractive-index films L21, L22, to L2j are silicon dioxide (SiO₂), and the high-refractive-index film H1, H2, to Hj are niobium (V) oxide (Nb₂O₅).

As shown in Curve C1, the cut-on wavelength is about 802.57 nm. As shown in Curve C2, the cut-on wavelength is about 888.47 nm. As shown in Curve C3, the cut-on wavelength is about 974.79 nm. As shown in Curve C4, the cut-on wavelength is about 1046.1 nm. Here, the cut-on wavelengths may be changed by adjusting Aᵢ, Aⱼ.

In some embodiments, the cut-on wavelength of the optical structure 100 is from about 850 nm to about 1550 nm. In one embodiment, when the design cut-on wavelength of the optical structure 100 is about 850 nm (i.e., T50=850 nm), A₁ may be between about 0.3 and about 0.4, A₂ may be between about 0.4 and about 0.5, A₃ may be between about 0.6 and about 0.7, A₄ may be between about 0.7 and about 0.8, and A₅ may be between about 0.8 and about 0.9. In another embodiment, when the design cut-on wavelength of the optical structure 100 is about 1550 nm (i.e., T50=1550 nm), A₁ may be between about 0.55 and about 0.75, A₂ may be between about 0.75 and about 0.95, A₃ may be between about 1.13 and about 1.31, A₄ may be between about 1.31 and about 1.51, and A₅ may be between about 1.51 and about 1.69.

In some embodiments, the total number of the first low-refractive-index films (i.e., L11, L12, to L1i), the semiconductor films (i.e., M1, M2, to Mi), the second low-refractive-index films (i.e., L21, L22, to L2j, L2k), and the high-refractive-index films (i.e., H1, H2, to Hj) is thirty to seventy-five. Moreover, in some embodiments, the total thickness of the first stack S1 and the second stack S2 is from about 5 μm to 6 about μm.

Table 1 lists the thickness of each first low-refractive-index film (i.e., L11, L12, to L15), each semiconductor film (i.e., M1, M2, to M5), each second low-refractive-index film (i.e., L21, L22, to L227, L228), and each high-refractive-index film (i.e., H1, H2, to H27) in an embodiment of the optical structure 100. Here, the design cut-on wavelength of the optical structure 100 is about 865 nm (i.e., T50=865 nm), angle of incidence (AOI) is 0, and the incident light is from air. Moreover, the total thickness of the first stack S1 (i.e., the first low-refractive-index films L11, L12, to L15 and the semiconductor films M1, M2, to M5) and the second stack S2 (i.e., the second low-refractive-index films L21, L22, to L227, L228 and the second low-refractive-index films L21, L22, to L227, L228) is about 5.55 μm.

TABLE 1

| Film | Material | Thickness (nm) |
|---|---|---|
| first low-refractive-index film L11 | SiO₂ | 100 |
| semiconductor film M1 | a-Si | 10 |
| first low-refractive-index film L12 | SiO₂ | 72.551 |
| semiconductor film M2 | a-Si | 21.92 |
| first low-refractive-index film L13 | SiO₂ | 73.218 |
| semiconductor film M3 | a-Si | 10.342 |
| first low-refractive-index film L14 | SiO₂ | 96.519 |
| semiconductor film M4 | a-Si | 11.963 |
| first low-refractive-index film L15 | SiO₂ | 83.951 |
| semiconductor film M5 | a-Si | 13.77 |
| second low-refractive-index film L21 | SiO₂ | 88.46 |
| high-refractive-index film H1 | Nb₂O₅ | 49.72 |
| second low-refractive-index film L22 | SiO₂ | 91.028 |
| high-refractive-index film H2 | Nb₂O₅ | 38.906 |
| second low-refractive-index film L23 | SiO₂ | 79.615 |
| high-refractive-index film H3 | Nb₂O₅ | 58.412 |
| second low-refractive-index film L24 | SiO₂ | 97.277 |
| high-refractive-index film H4 | Nb₂O₅ | 63.064 |
| second low-refractive-index film L25 | SiO₂ | 98.267 |
| high-refractive-index film H5 | Nb₂O₅ | 49.333 |
| second low-refractive-index film L26 | SiO₂ | 111.504 |
| high-refractive-index film H6 | Nb₂O₅ | 61.191 |
| second low-refractive-index film L27 | SiO₂ | 109.678 |
| high-refractive-index film H7 | Nb₂O₅ | 73.204 |
| second low-refractive-index film L28 | SiO₂ | 108.445 |
| high-refractive-index film H8 | Nb₂O₅ | 69.177 |
| second low-refractive-index film L29 | SiO₂ | 101.148 |
| high-refractive-index film H9 | Nb₂O₅ | 56.436 |
| second low-refractive-index film L210 | SiO₂ | 90.223 |
| high-refractive-index film H10 | Nb₂O₅ | 69.821 |
| second low-refractive-index film L211 | SiO₂ | 113.21 |
| high-refractive-index film H11 | Nb₂O₅ | 75.496 |
| second low-refractive-index film L212 | SiO₂ | 115.84 |
| high-refractive-index film H12 | Nb₂O₅ | 78.174 |
| second low-refractive-index film L213 | SiO₂ | 108.06 |
| high-refractive-index film H13 | Nb₂O₅ | 57.144 |
| second low-refractive-index film L214 | SiO₂ | 97.031 |
| high-refractive-index film H14 | Nb₂O₅ | 48.916 |
| second low-refractive-index film L215 | SiO₂ | 106.804 |
| high-refractive-index film H15 | Nb₂O₅ | 75.74 |
| second low-refractive-index film L216 | SiO₂ | 129.622 |
| high-refractive-index film H16 | Nb₂O₅ | 79.865 |
| second low-refractive-index film L217 | SiO₂ | 122.596 |
| high-refractive-index film H17 | Nb₂O₅ | 88.152 |
| second low-refractive-index film L218 | SiO₂ | 125.641 |
| high-refractive-index film H18 | Nb₂O₅ | 86.144 |
| second low-refractive-index film L219 | SiO₂ | 126.032 |
| high-refractive-index film H19 | Nb₂O₅ | 85.216 |
| second low-refractive-index film L220 | SiO₂ | 128.065 |
| high-refractive-index film H20 | Nb₂O₅ | 84.997 |
| second low-refractive-index film L221 | SiO₂ | 129.588 |
| high-refractive-index film H21 | Nb₂O₅ | 88.443 |
| second low-refractive-index film L222 | SiO₂ | 128.868 |
| high-refractive-index film H22 | Nb₂O₅ | 86.824 |
| second low-refractive-index film L223 | SiO₂ | 127.2 |
| high-refractive-index film H23 | Nb₂O₅ | 83.398 |
| second low-refractive-index film L224 | SiO₂ | 129.233 |
| high-refractive-index film H24 | Nb₂O₅ | 85.397 |
| second low-refractive-index film L225 | SiO₂ | 129.134 |
| high-refractive-index film H25 | Nb₂O₅ | 82.097 |
| second low-refractive-index film L226 | SiO₂ | 122.563 |
| high-refractive-index film H26 | Nb₂O₅ | 72.936 |
| second low-refractive-index film L227 | SiO₂ | 119.792 |
| high-refractive-index film H27 | Nb₂O₅ | 78.995 |
| second low-refractive-index film L228 | SiO₂ | 100 |

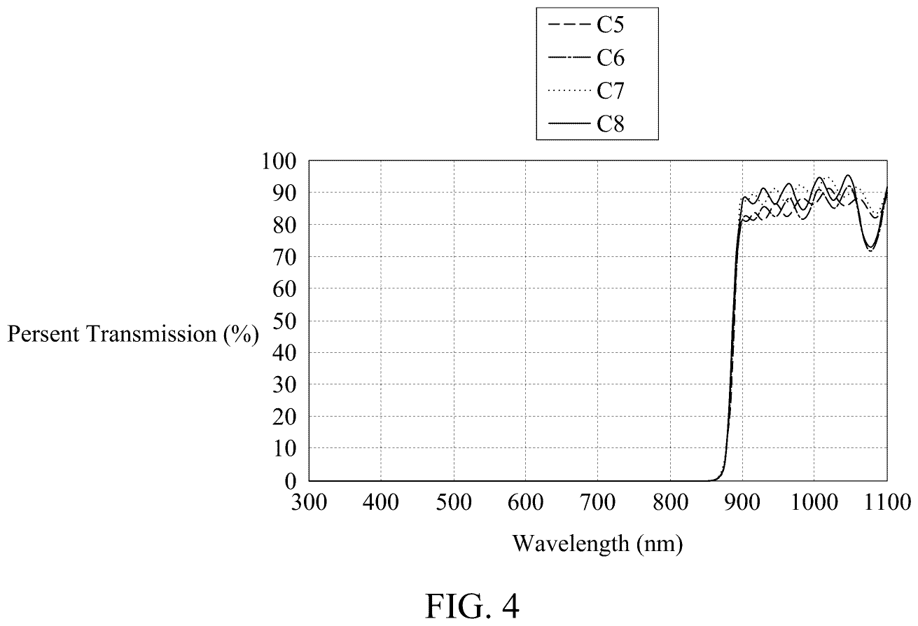

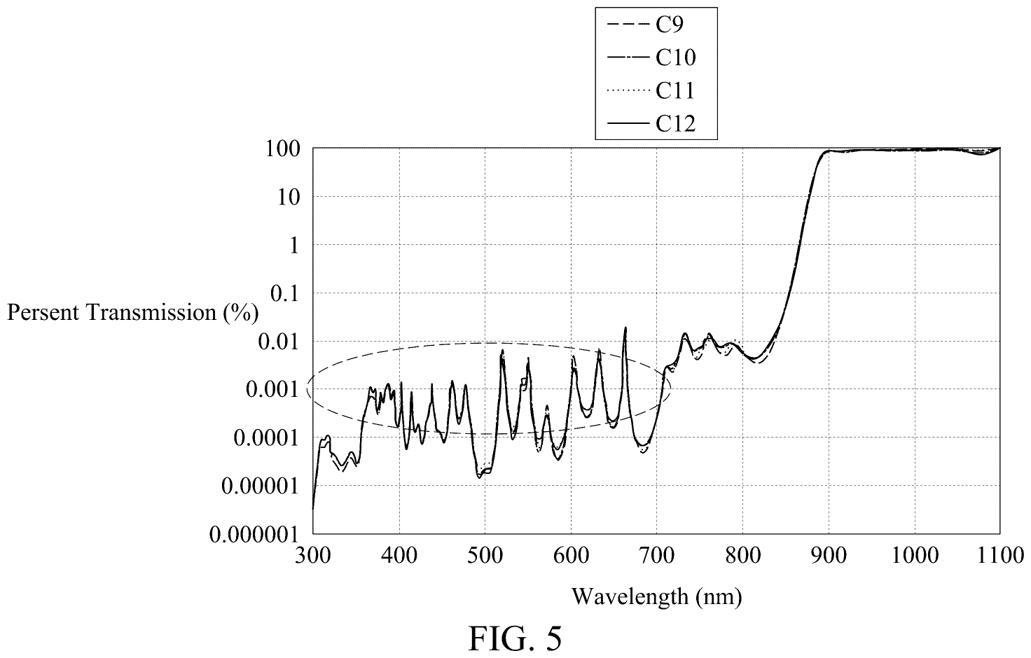

FIG. 4 illustrates different transmissions of incident lights that have different wavelengths into the optical structure 100 according to some embodiments of the present disclosure, where X-axis represents wavelength (unit: nm) and Y-axis represents percent transmission (%). FIG. 5 illustrates different transmissions of incident lights that have different wavelengths into the optical structure 100 in a logarithmic scale (or log scale) according to some embodiments of the present disclosure, where X-axis represents wavelength (unit: nm) and Y-axis represents percent transmission (%) (in a logarithmic scale).

In this embodiment, the design cut-on wavelength of the optical structure 100 is almost 900 nm (i.e., T50 near 900 nm), angle of incidence (AOI) is 0, and. Moreover, the total thickness of the first stack S1 and the second stack S2 is about 5.56 μm.

In FIG. 4, Curve C5 represent the incident light is from air before the optical structure 100 is baked in an oven, Curve C6 represent the incident light is from epoxy before the optical structure 100 is baked in an oven, Curve C7 represent the incident light is from air after the optical structure 100 is baked in an oven, and Curve C8 represent the incident light is from epoxy after the optical structure 100 is baked in an oven. As shown in Curves C5-C8 in FIG. 4, the optical structure 100 may achieve high transmittance into infrared light.

In FIG. 5, Curve C9 represent the incident light is from air before the optical structure 100 is baked in an oven, Curve C10 represent the incident light is from epoxy before the optical structure 100 is baked in an oven, Curve C11 represent the incident light is from air after the optical structure 100 is baked in an oven, and Curve C12 represent the incident light is from epoxy after the optical structure 100 is baked in an oven. As shown in Curves C9-C12 in FIG. 5, in some embodiment, the average transmittance of the optical structure 100 is less than or equal to 10⁻⁵ in the range of visible light wavelengths (see the dotted circle in FIG. 5). That is, the optical structure 100 may effectively filter visible light.

As noted above, the optical structure according to the embodiments of the present disclosure includes a first stack and a second stack disposed on the first stack. The first stack and the second stack each includes specific stacked films, which may effectively filter visible light and achieve high transmittance into infrared light.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. An optical structure, comprising:
a substrate;
a first stack disposed on the substrate, wherein the first stack comprises alternately stacked first low-refractive-index films and semiconductor films; and
a second stack disposed on the first stack; wherein the second stack comprises alternately stacked second low-refractive-index films and high-refractive-index films,
wherein a refractive index of each of the first low-refractive-index films and the second low-refractive-index films is less than a refractive index of each of the high-refractive-index films.

2. The optical structure as claimed in claim 1, wherein the semiconductor films comprise amorphous silicon.

3. The optical structure as claimed in claim 1, wherein the first low-refractive-index films and the second low-refractive-index films comprise silicon dioxide, aluminum oxide, silicon nitride, or a combination thereof.

4. The optical structure as claimed in claim 1, wherein the high-refractive-index films comprise titanium dioxide, niobium(V) oxide, tantalum(V) oxide, silane, or a combination thereof.

5. The optical structure as claimed in claim 1, wherein the substrate comprises glass.

6. The optical structure as claimed in claim 1, wherein a thickness of the i-th first low-refractive-index film among the first low-refractive-index films in the first stack is Aᵢ×cᵢ×L, a thickness of the i-th semiconductor films among the semiconductor films in the first stack is Aᵢ×dᵢ×M, where L, M are λ/4 optical thickness, λ is a design wavelength or a wavelength being optimized for peak performance, Aᵢ×cᵢ×L and Aᵢ×dᵢ×M are set to cut off light with a wavelength of 300 nm to 600 nm, Aᵢ means a bracket coefficient and stands for a scale factor of a design wavelength, and ci, di mean the times of λ/4 optical thickness.

7. The optical structure as claimed in claim 6, wherein Aᵢ is adjustable to make different cut-on wavelengths of the optical structure.

8. The optical structure as claimed in claim 6, wherein Aᵢ is greater than or equal to 0.1 and less than or equal to 1.5, cᵢ is greater than or equal to 0 and less than or equal to 2.5, and dᵢ is substantially equal to 1.

9. The optical structure as claimed in claim 1, wherein a thickness of the j-th second low-refractive-index film among the second low-refractive-index films in the second stack is Aⱼ×cⱼ×L, a thickness of the j-th high-refractive-index film among the high-refractive-index films in the second stack is Aⱼ×dⱼ×H, a thickness of a second low-refractive-index film among the second low-refractive-index films closest to the substrate is cₖ×L, where L, H are λ/4 optical thickness, λ is a design wavelength or a wavelength being optimized for peak performance, Aⱼ×cⱼ×L, Aⱼ×dⱼ×H, and cₖ×L are set to cut off light with a wavelength of about 600 nm to about 800 nm, Aⱼ means the bracket coefficient and stands for the scale factor of the design wavelength, and cⱼ, dⱼ, cₖ mean the times of λ/4 optical thickness.

10. The optical structure as claimed in claim 9, wherein Aⱼ is adjustable to make different cut-on wavelengths of the optical structure.

11. The optical structure as claimed in claim 9, wherein Aⱼ is greater than or equal to 0.1 and less than or equal to 1.5, cⱼ, cₖ are greater than or equal to 0 and less than or equal to 2.5, and dⱼ is substantially equal to 1.

12. The optical structure as claimed in claim 1, wherein a cut-on wavelength of the optical structure is from 850 nm to 1550 nm.

13. The optical structure as claimed in claim 1, wherein an average transmittance of the optical structure is less than or equal to 10⁻⁵ in the range of visible light wavelengths.

14. The optical structure as claimed in claim 1, wherein a total number of the first low-refractive-index films, the semiconductor films, the second low-refractive-index films, and the high-refractive-index films is thirty to seventy-five.

15. The optical structure as claimed in claim 1, wherein a total thickness of the first stack and the second stack is from 5 μm to 6 μm.

16. The optical structure as claimed in claim 1, wherein a refractive index of the first low-refractive-index films and the second low-refractive-index films is less than or equal to 1.5.

17. The optical structure as claimed in claim 1, wherein a refractive index of the high-refractive-index films is greater than 1.5.
